(19) United States
(12) Patent Application Publication
(10) Pub. No.: US 2009/0055818 A1
(43) Pub. Date: Feb. 26, 2009

(54) METHOD FOR SUPPORTING, SOFTWARE SUPPORT AGENT AND COMPUTER SYSTEM

(75) Inventors: JIAN HONG CHENG, BEIJING (CN); Xiao Wei Hu, Beijing (CN); Da Li Yin, Beijing (CN)

Correspondence Address: PATENTS ON DEMAND, P.A. - IBM Lotus, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/196,968

(22) Filed: Aug. 22, 2008

(30) Foreign Application Priority Data
Aug. 22, 2007 (CN) 200710146584.3

(51) Int. Cl. G06F 9/445; G06F 15/16

(52) U.S. Cl. 717/173; 709/202

(57) ABSTRACT

Information can be automatically collected related to running of software. The collected information can be packed into a message format of a messaging software. The collected information related to running of the software can be sent by using the messaging software.

### CROSS-REFERENCE TO RELATED APPLICATIONS

This application claims the benefit of Chinese Patent Application No. 200710146584.3 filed 22 Aug. 2007 and which is hereby incorporated by reference.

### BACKGROUND

The present invention relates to data processing, more particularly to technology of providing support to software.

Technological advances have resulted in an increase in software executable upon computing devices. Although developers of software do their best to ensure software has been fully tested and that software bugs have been removed before release, it can be difficult to catch all potential problems before deployment. Many different software faults remain in deployed software, which significantly detract from an end-user experience.

One kind of fault is that the software unexpectedly crashes, which can result in unsaved data being lost. Another kind of fault is an installation fault generated when an attempt to install software is made. An installation fault can render at least a portion of the software unusable. Still another fault is an execution fault, which does not result in a crash, but which produces unexpected behavior. Sometimes, in order to improve the running performance of software, a vendor, software developer, software maintainer, or troubleshooting technician needs to collect information related to the running of the software and/or needs to provide guidance to a remotely located software user.

Many different technologies exist that provide support for software, which include extracting and collecting information related to runtime behavior of a remote system. For example, location of the fault, type of the fault, running parameters, etc., can be captured from a fault experiencing device and sent to a supporter of the software. This permits the supporter to diagnose the faults and to take corrective actions. Existing solutions include, but are not limited to, IBM SUPPORT ASSISTANT (ISA), CRASH DIAGNOSIS TOOL of SUN SOLARIS, ERROR REPORT MECHANISM of MICROSOFT, and the like.

Existing solutions collect information related to the erratic software behavior in the background by using a software support agent program. The collected information can be sent to a supporter of the software. This conveyance of data can occur secretly, overtly, and can optionally require user permissions, which are prompted for. Even when users are prompted to permit diagnostic information to be sent, the user is not aware of the actually content that is to be conveyed. Thus, the problem of security and privacy exists, where confidential and/or personal information is often conveyed that a user would not agree to, were that user aware of the conveyance.

To illustrate, MICROSOFT provides a support mechanism to operating systems, which collects information when a fault occurs in the operating system. It generates a report and sends it to MICROSOFT for diagnosing. It communicates by using a special message format and protocol, and requires a special network port. Thereby, although it allows a user to view a fault report, the problem of privacy and security still exists. For example, some otherwise private information is sent to Microsoft without telling the user.

Additionally, the viewable fault reports are generally not construed in user digestible or understandable manner. Further, the support mechanism does not save information in a local storage medium. Thus, it cannot be accessed by a user when a computer is off-line or when the user is busy and does not want to affirm whether to send or not. Moreover, the support mechanism does not allow the user to modify information in order to delete some sensitive information before conveyance.

Other existing solutions are similarly flawed in that they either provide insufficient privacy protection or require an unreasonable level of technical knowledge of a user. For example, CRASH DIAGNOSIS TOOL of SUN SOLARIS requires the user to use an appropriate tool and solution in a database or network, and run the tool manually to generate information related to the runtime behavior, and then to send the generated information to a support entity. This generally results that the support entity possessing insufficient information to identify and solve the fault, because the user does not know technique details of the software product, and cannot obtain all required information. Further, the CRASH DIAGNOSIS TOOL requires the user to execute multi steps, takes the user a lot of time and experience, and requires the user to have professional knowledge for using the tool.

Thus, existing methods and the systems for providing support to software provide support separately for each other, require a user to have professional knowledge of the support system of each software package, and fail to provide adequate mechanisms to ensure security and privacy of conveyed data.

### SUMMARY

According to one aspect of the present invention, there is provided a method for supporting software that includes: automatically collecting information related to running of the software; packing the collected information into a message format of a messaging software; and sending the collected information related to running of the software by using the messaging software.

According to another aspect of the present invention, there is provided software support agent, comprising: an information collecting unit configured to automatically collecting information related to running of the software; an information packing unit configured to pack the information collected by the information collecting unit into a message format of a messaging software; and an information sending unit configured to send the collected information related to running of the software by using the messaging software.

According to another aspect of the present invention, there is provided a computer system, comprising: the above-mentioned software support agent; and the above-mentioned messaging software.

### BRIEF DESCRIPTION OF THE SEVERAL VIEWS OF THE DRAWINGS

FIG. 1 is a flowchart showing a method for supporting software according to an embodiment of the present invention;

FIG. 2 is a detailed flowchart showing a method for supporting software according to the embodiment of the present invention;

FIG. 3 is an example showing an interface of messaging software according to the embodiment of the present invention;

FIG. 4 is another example showing an interface of messaging software according to the embodiment of the present invention;

FIG. 5 is another example showing an interface of messaging software according to the embodiment of the present invention;

FIG. 6 is a block diagram showing a software support agent according to another embodiment of the present invention; and

FIG. 7 is a block diagram showing a computer system according to another embodiment of the present invention.

### DETAILED DESCRIPTION

Next, a detailed description of each embodiment of the present invention will be given in conjunction with the accompany drawings.

### Method for Supporting Software

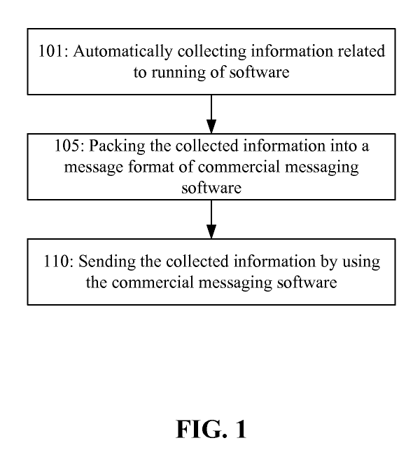

FIG. 1 is a flowchart showing a method for supporting software according to an embodiment of the present invention. As shown in FIG. 1, first at Step 101, information related to running of the software is collected by a software support agent program automatically or by a user manually. Specifically, the software is any program module which can run in a computer and realize a certain function. The software can include, but is not limited to, operating system software, database software, various office software, a browser, a digital dictionary and other application software, etc. The disclosure is not to be construed as limited to any particular type of software.

The information related to running of the software collected at Step 101 can be any information generated in the running of the software. That is, the invention can include any information helpful to provide support to the software. For example, information can include current host computer location/identifier, location of a fault occurring, type of a fault, running parameters of the software, and so on. This information can be used to diagnose the reason that a fault occurs, analyze the running bottleneck of software or a system, or provide help to update the software. The present disclosure asserts no limitation to the information required to be collected.

At Step 101, the method for collecting information related to running of the software can be performed in various manners. For example, any or all of the capturing methodologies and/or techniques used in ISA of IBM, ERROR REPORT MECHANISM of MICROSOFT, CRASH DIAGNOSIS TOOL of SUN SOLARIS, etc. can be utilized herein. The present disclosure has no limitation to the method for collecting the above-mentioned information.

Next, at Step 105, the information collected at Step 101 is packed into a message format of messaging software. At this step, the message format packed can be any message format of any messaging software as known in the art, for example, a message format of Email (e.g., LOTUS NOTES of IBM, OUTLOOK of MICROSOFT etc.,) or a message format of Instant Message (e.g., MSN of MICROSOFT, LOTUS SAMETIME of IBM etc.,), and the like. Any message format of any message exchange software can be utilized. Hence, the present disclosure is not to be construed as limited in this regard.

Next, at Step 110, the information collected at Step 101 related to running of the software is sent in the message format packed at Step 105 by using the messaging software. The messaging software used at Step 110 can be any variety of software able to convey a message between a user and software support entity.

In one embodiment, intercommunication between the software support agent program and the messaging software can be realized by using a Local Service Platform. The Local Service Platform can be any platform provided by an operating system of a computer system. Communication between the software support agent program and the messaging software can be established in any manner, and the present disclosure has no limitation in this regard.

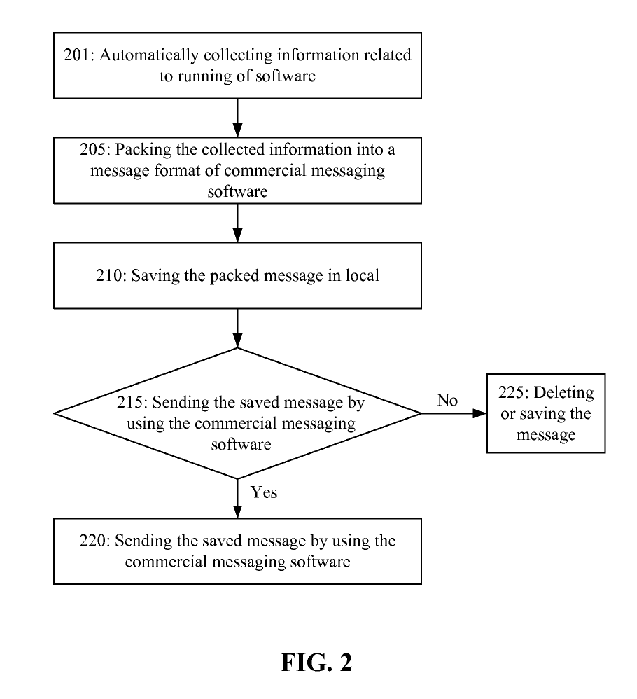

FIG. 2 is a detailed flowchart showing a method for supporting software according to the embodiment of the present invention. In FIG. 2, at Step 201, information related to running of the software is automatically collected.

The information collected at Step 201 related to running of the software can be any information mentioned at Step 101. The present disclosure has no limitation to the information required to be collected, which is appropriately omitted herein.

At Step 201, the method for collecting information related to running of the software can be any method mentioned at Step 101, and the present disclosure has no limitation to the method for collecting the information, which is appropriately omitted herein.

Next, at Step 205, the information collected at Step 201 is packed into a message format of messaging software. At this step, the message format packed can be any message format of any messaging software so long as information is able to be exchanged using this software.

Next, at Step 210, the message packed at Step 205 is saved in local computer. At this step, the message packed can be saved in a pre-set location, or the message packed can be saved in a pre-set location of the messaging software by using the messaging software (e.g., a sending box of Email). The present disclosure is not to be construed as limited in this regard.

Next, at Step 215, a user is allowed to determine whether to send the message saved at Step 210 to a vendor or a developer or not. At this step, if the user determines not to send the saved message to the vendor, the method goes to Step 225, and at Step 225, the message un-sent is saved in order to be sent in the future, or optionally, the user can delete the message. On the other hand, in this step, if the user determines to send the saved message to the vendor, the method goes to Step 220, and at Step 220, the saved message is sent to the vendor by using the messaging software (e.g., the saved message is sent to the vendor by Email or Instant Message).

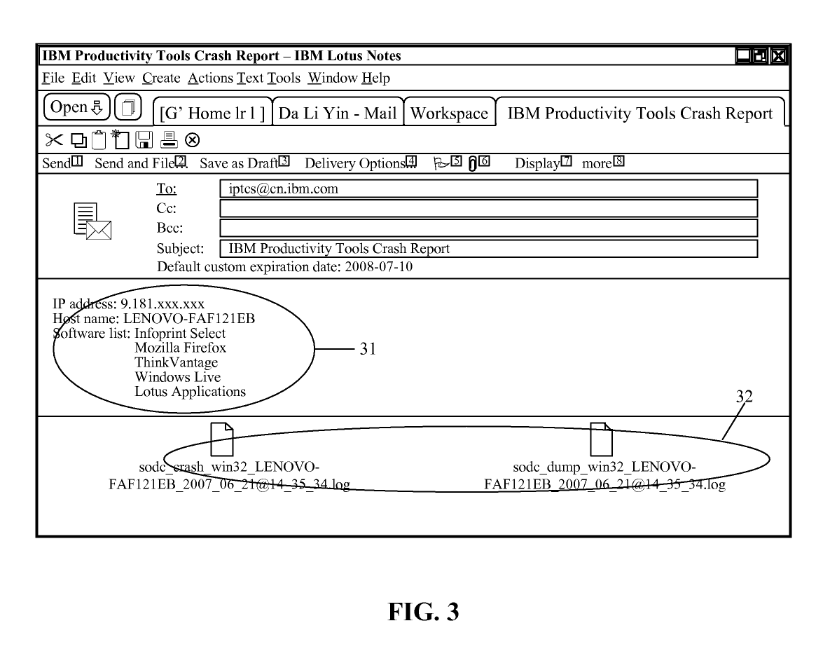

Further, before Step 215, (i.e., before the user determines to send the message to the vendor or not) the user is allowed to view and/or edit the message in the method for supporting software of the present invention. The message can be presented to the user in a manner that the message can be read by the user in the method of the present invention (e.g., the message is presented in a manner of Email). Specifically, the user can view and/or edit the message in an interface of the messaging software. For example, if the user finds a privacy problem in the message, the user can delete the involved privacy, a detailed description of which will be given in conjunction with FIGS. 3-5.

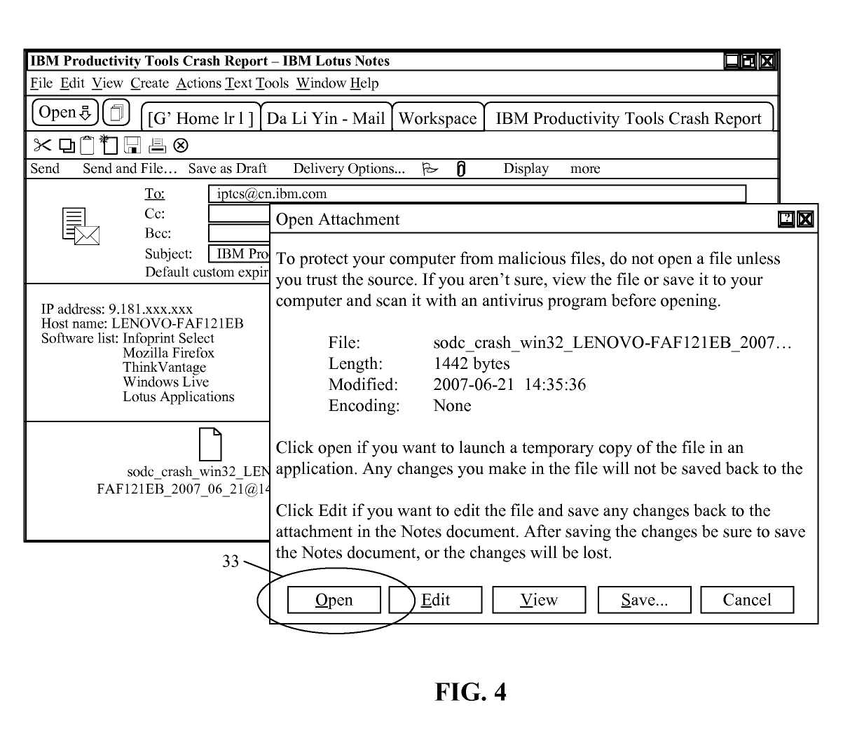

FIG. 3 is an example showing an interface of messaging software according to the embodiment of the present invention. In FIG. 3, a generated Email interface of LOTUS NOTES of IBM is show. Additionally, an Email address of a vendor (e.g., software support entity) is shown in the sending address column, some information related to the fault occurrence of the software is shown in the Email content 31, and two log files related to the fault occurrence of the software are shown in the appendix 32. The user can modify the Email content 31 in this interface and can open the appendix 32. An interface shown in FIG. 4 is obtained after one file in the appendix 32 is opened.

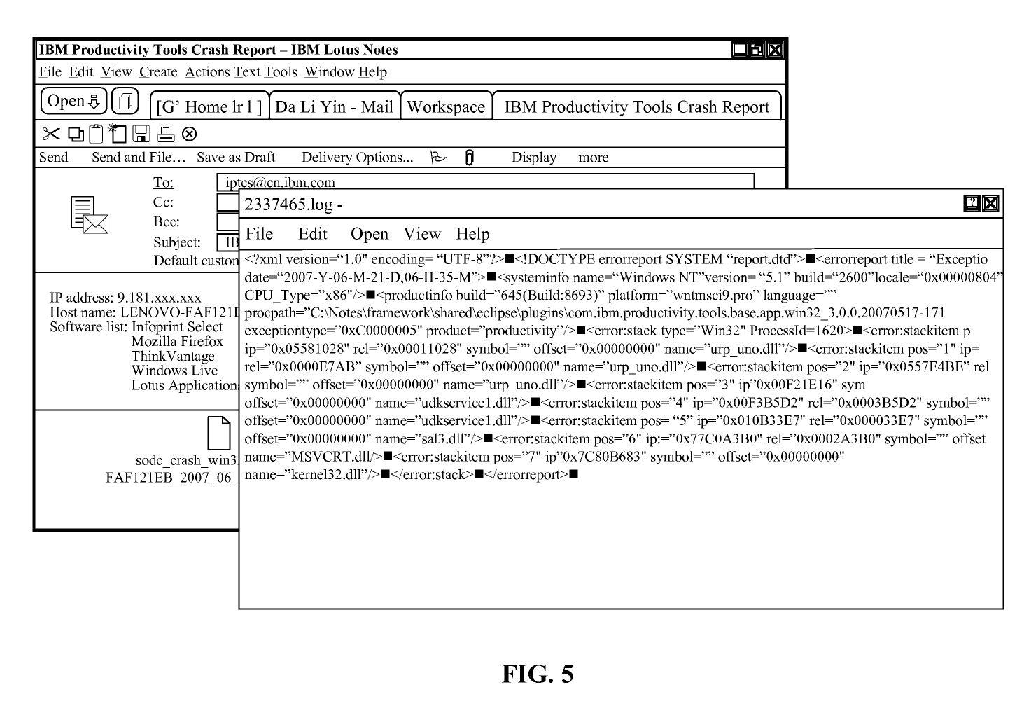

FIG. 4 is another example showing an interface of messaging software according to the embodiment of the present invention. In FIG. 4, after one file in the appendix 32 is opened, a pop-up window is presented. In this window, the user can choose “Open” to view the content of the appendix, or can choose “Edit” to modify the content of the appendix. An interface shown in FIG. 5 is obtained after “Open” is clicked by a mouse.

FIG. 5 is another example showing an interface of messaging software according to the embodiment of the present invention. In FIG. 5, the window of the content of the appendix is pop-up, and a user can view the content of the appendix in this window.

Though the method for supporting software of the embodiment has been described in details with examples of Email and LOTUS NOTES interfaces, it should be understood that, any messaging software can be used and any type of information interface can be generated in the method of the embodiment. The interface should permit a user to view and/or edit content.

Further, in one embodiment, return information and/or an update program from the vendor (e.g., software support entity) of the software also can be received by using the messaging software in the method for supporting software of the present disclosure. After the return information and/or update program is received, the user is allowed to view the received return information and/or update program, and determine whether to recover and/or update the related software or not by using the return information and/or update program in the method of the present invention. If it is determined to recover and/or update, the return program and/or update program can be sent to the related software in the method of the present invention. If it is determined not to recover and/or update, and optionally, the received return information and/or update program can be deleted, or saved in order to recover and/or update the software in the future.

Through the method for supporting software of the embodiment, the information related to running of the software is automatically collected and packed into a message format, and it is not needed for the user to perform multiple operations. Communication between the software and the vendor is performed by using the messaging software. A uniform interface is provided for a user to manage the software support. Thereby, the user is not required to possess professional knowledge related to each software. Further, the user can leverage knowledge from one system and apply it to the next. Thus, the solution is very convenient for the user, results in time being saved, and results in efficiency improvements.

Further, through the method for supporting software of the embodiment, the user can view and modify the generated message, and determine whether to send it to a vendor or not. The user also can view the return information and/or update program from the vendor, and determine whether to recover and/or update the software or not. Therefore, the problem of privacy and security is solved. The user no longer needs to worry about his/her own privacy being compromised and/or about his/her computer being attacked by a virus program or being infested with other malware.

Further, through the method for supporting software of the embodiment, the generated message can be saved in a local storage medium by leveraging the messaging software's data management capabilities. Thus, the information related to running of the software can be collected by using the method of the embodiment when off-line or when the user is busy. Communication with the vendor can be performed when on-line or the user is not busy. Moreover, the user is not required to study different operation methods of different support systems according to different software since the messaging software is used. This results in usability improvements.

Further, the method for supporting software of the embodiment can be realized through slight modifications to existing-off-the-shelf software packages. Thus, implementation and maintain cost can be relatively low. Wide scale adoption of the disclosed solution can be anticipated, as a pre-existing base of software is already deployed and present. In one embodiment, a plug-in to an existing messaging application can provide the disclosed functionality. In another embodiment, a Web service can enhance an existing product to provide the functionality disclosed herein.

### Software Support Agent

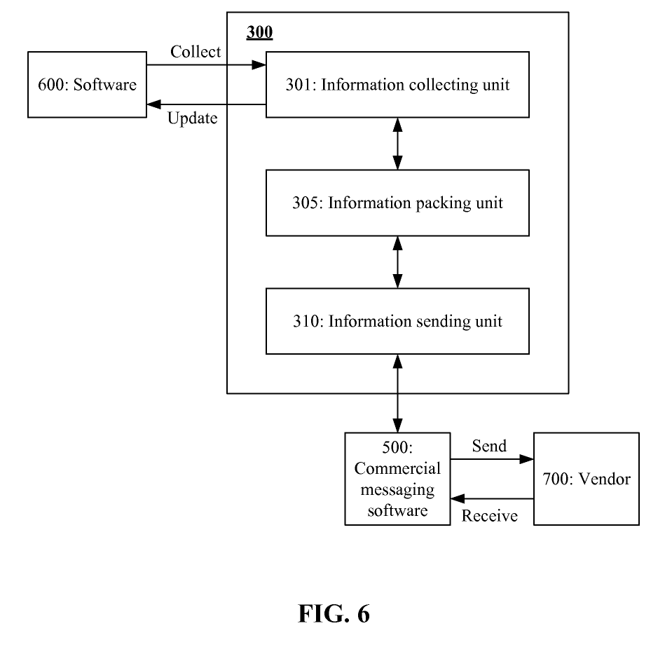

Under the same inventive conception, FIG. 6 is a block diagram showing a software support agent according to another embodiment of the present invention. Next, the present embodiment will be described in conjunction with FIG. 6. For those same parts as the above embodiment, the description of which will be appropriately omitted.

As shown in FIG. 6, the software support agent 300 in this embodiment includes: an information collecting unit 301 configured to automatically collect information related to running of software 600; an information packing unit 305 configured to pack the information collected by the information collecting unit 301 into a message format of a messaging software; and an information sending unit 310 configured to send the information collected by the information collecting unit 301 related to running of the software in the message format packed by the information packing unit 305 by using a messaging software 500.

As shown, the software 600 can be any program module which can be run in a computer and realize a certain function (e.g., an operating system software, a database software, various office software, a browser, a digital dictionary and other application software etc.). The present disclosure is not to be construed as limited to the software mentioned herein.

The information collecting unit 301 can be any information collecting unit permitting information to be captured relating to the running process of the software (e.g., ISA of IBM, ERROR REPORT MECHANISM of MICROSOFT, CRASH DIAGNOSIS TOOL of SUN SOLARIS etc.). The present disclosure has no limitation to the information collecting unit 301.

The information related to running of the software collected by the information collecting unit 301 can be any information generated in the running process of the software (i.e., can be any information helpful to provide support to the software). For example, the information can include current location of a course, location of a fault occurring, type of a fault, running parameters of software, and so on. This information can be used to diagnose the reason that a fault occurs, analyze the running bottleneck of software or a system, provide help to update the software, and the like. The present invention has no limitation to the information required to be collected.

The messaging software 500 can be any messaging software permitting information can be sent between a user and a vendor of software. For example, the messaging software can include Email software (e.g., LOTUS NOTES of IBM, OUTLOOK of MICROSOFT, etc.), or Instant Message software (e.g., MSN of MICROSOFT, LOTUS SAMETIME of IBM etc.), text messaging software, teleconference software, chat software, co-browsing software, file-sharing software, and the like. The present disclosure has no limitation in this regard.

In one embodiment, the information packing unit 305 can be any information packing unit. The packing unit 305 can pack information into a pre-determined message format. The message format packed by the information packing unit 305 can be any message format of any messaging software. For example, the messaging format can conform to email standards, IM standards, etc.

In one embodiment, the information sending unit 310 can be any information sending unit, such that the information collected by the information collecting unit 301 can be sent to the messaging software 500. After the information related to running of the software 600 is collected by the information collecting unit 301, the collected information is sent to the messaging software 500 by the information sending unit 310 through a Local Service Platform. The Local Service Platform can be any service platform as known in the art, for example, computer operating system etc., and the present disclosure has no limitation to this.

Further, in one embodiment, the software support agent 300 also includes an information saving unit configured to save the information collected by the information collecting unit 301 or the message packed by the information packing unit 305 in a local storage medium. In this embodiment, the information collected by the information collecting unit 301 or the message packed by the information packing unit 305 can be saved in a pre-set location defined by the information saving unit 305, or can be saved in a pre-set location of the messaging software by using the messaging software 500 (e.g., a sending box of Email).

Further, in one embodiment, a user is also allowed in the software support agent 300 to determine whether to send the saved message by the information saving unit to a vendor or a developer 700 or not. If a user determines not to send the saved message to the vendor 700, the message un-sent is saved in order to be sent in the future, or optionally, the user also can delete the message. On the other hand, if the user determines to send the saved message to the vendor 700, the saved message is sent to the vendor 700 by using the messaging software 500 (i.e., the saved message is sent to the vendor 700 by Email or Instant Message).

Further, in one embodiment, intercommunication between the software support agent 300 and the messaging software 500 can be realized by using a Local Service Platform. The Local Service Platform can be any platform provided by an operating system of a computer system, such that communication between the software support agent 300 and the messaging software 500 can be established.

Further, in one embodiment, before the user determines whether to send the message to the vendor 700 or not, the user is allowed to view and/or edit the message in the messaging software 500 of the present invention. The message can be presented to the user in a manner that the message can be read by the user, (i.e., the message is presented in a manner of Email). Specifically, the user can view and/or edit the message in an interface of the messaging software 500. For example, if the user finds a problem of privacy in the message, the user can delete the privacy involved, the detailed description part of which has been given in conjunction with FIGS. 3-5.

Though the software support agent 300 of the embodiment has been described in details with examples of Email and LOTUS NOTES interfaces, it should be understood that, any messaging software can be used and any type of information interface can be generated by the software support agent 300. This interface can make it convenient for a user to view and/or edit content.

Further, in one embodiment, return information and/or an update program from the vendor 700 of the software also can be received by using the messaging software 500 in the software support agent 300. After the return information and/or update program from the vendor 700 is received by the messaging software 500, the user is also allowed to view the received return information and/or update program, and determine whether to recover and/or update the related software or not by using the return information and/or update program in the software support agent 300. If it is determined to recover and/or update, the return program and/or update program will be sent to the related software. When, it is determined not to recover and/or update, the received return information and/or update program can be deleted, or saved in order to recover and/or update the software in the future.

Through the software support agent 300 of one embodiment, the information related to running of the software is automatically collected and packed into a message format. The user does not need to perform multiple operations. Communication between the software and a vendor is performed by using the messaging software, and a uniform interface is provided for a user to manage the software support. Thereby, the user is not required to possess professional knowledge related to each software application utilized. Use of a uniform interface is very convenient for the user, saves time, and improves efficiency.

Further, through the software support agent 300 of one embodiment, the user can view and modify the generated message, and determine whether to send it to a vendor or not. The user also can view the return information and/or update program from the vendor, and determine whether to recover and/or update the software or not. Therefore, the problem of privacy and security is solved. The user no longer needs to worry about his/her own privacy being compromised and/or about his/her computer being attacked by a virus program or being infested with other malware.

Further, through the software support agent 300 of one embodiment, the generated message can be saved in a local storage medium by leveraging the messaging software's data management capabilities. Thus, the information related to running of the software can be collected by using the method of the embodiment when off-line or when the user is busy. Communication with the vendor can be performed when on-line or the user is not busy. Moreover, the user is not required to study different operation methods of different support systems according to different software since the messaging software is used. This results in usability improvements.

Further, through the software support agent 300 of one embodiment can be realized through slight modifications to existing-off-the-shelf software packages. Thus, implementation and maintain cost can be relatively low. Wide scale adoption of the disclosed solution can be anticipated, as a pre-existing base of software is already deployed and present. In one embodiment, a plug-in to an existing messaging application can provide the disclosed functionality. In another embodiment, a Web service can enhance an existing product to provide the functionality disclosed herein.

### Computer System

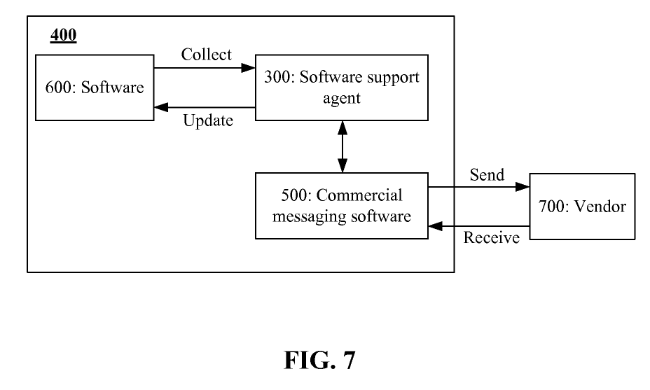

Under the same inventive conception, FIG. 7 is a block diagram showing a computer system according to another embodiment of the present invention. Next, the present embodiment will be described in conjunction with FIG. 7. For those same parts as the above embodiments, the description of which will be appropriately omitted.

As shown in FIG. 7, a computer system 400 in this embodiment comprises the above-mentioned software support agent 300, the above-mentioned software 600 and the above-mentioned messaging software 500.

In this embodiment, information related to running of the software 600 is collected by using the software support agent 300, and the collected information is sent to the vendor 700 by using the messaging software 500 in the computer system 400. Before sending, a user is also allowed to view and/or edit the collected information, and determine whether to send the collected information to the vendor 700 or not in the computer system 400 of the embodiment.

Further, return information and/or an update program from the vendor 700 also can be received by using the messaging software 500 in the computer system 400 of the embodiment, and the software 600 can be recovered and/or updated by using the received return information and/or update program. Before recovering and/or updating, the user is allowed to view the received return information and/or update program, and determine whether to recover and/or update or not in the computer system 400 of the embodiment.

Through the computer system 400 of the embodiment, the information related to running of the software is automatically collected and packed into a message format, and it is not needed for the user to do a set of operations. Communication between the software and a vendor is performed by using the messaging software, and a uniform interface is provided for a user to manage the software support. Thereby, the user is not required to study professional knowledge related the software, and it is very convenient for the user, time is saved, and efficiency is improved.

Further, through the computer system 400 of the embodiment, the user can view and modify the generated message, and determine whether to send it to a vendor or not. The user also can view the return information and/or update program from the vendor, and determine whether to recover and/or update the software or not. Therefore, the problem of privacy and security is solved. The user no longer needs to worry about his/her own privacy being compromised and/or about his/her computer being attacked by a virus program or being infested with other malware.

Further, through the computer system 400 of the embodiment, the generated message can be saved in a local storage medium by leveraging the messaging software's data management capabilities. Thus, the information related to running of the software can be collected by using the method of the embodiment when off-line or when the user is busy. Communication with the vendor can be performed when on-line or the user is not busy. Moreover, the user is not required to study different operation methods of different support systems according to different software since the messaging software is used. This results in usability improvements.

Further, the computer system 400 can be realized through slight modifications to existing commercial-off-the-shelf software packages. Thus, implementation and maintain cost can be relatively low. Wide scale adoption of the disclosed solution can be anticipated, as a pre-existing base of software is already deployed and present. In one embodiment, a plug-in to an existing messaging application can provide the disclosed functionality. In another embodiment, a Web service can enhance an existing product to provide the functionality disclosed herein.

Through a method for supporting software, a software support agent and a computer system have been described in detail with some exemplary embodiments; these above embodiments are not exhaustive. Those skilled in the art can make various variations and modifications within the spirit and the scope of the present invention. Therefore, the present invention is not limited to these embodiments; rather, the scope of the present invention is only defined by the appended claims.

What is claimed is:

1. A method for supporting software, comprising:
automatically collecting information related to running of software;
packing said collected information into a message format of a messaging software; and
sending said collected information related to running of said software by using said messaging software.

2. The method according to claim 1, wherein a user is allowed to determine whether to send said information to a vendor of said software or not before sending said collected information related to running of said software by using said messaging software.

3. The method according to claim 1, wherein a user is allowed to view and/or edit said information before sending said collected information related to running of said software by using said messaging software.

4. The method according to any one of claim 1, further comprising:
saving said information in local storage medium with said message format of said messaging software.

5. The method according to any one of claim 1, further comprising:
receiving return information and/or an update program from said vendor of said software by using said messaging software.

6. The method according to claim 5, further comprising:
updating said software by using said update program.

7. The method according to claim 6, wherein a user is allowed to determine whether to update or not before updating said software by using said update program.

8. A software support agent, comprising:
an information collecting unit configured to automatically collecting information related to running of said software;
an information packing unit configured to pack said information collected by said information collecting unit into a message format of a messaging software; and
an information sending unit configured to send said collected information related to running of said software by using said messaging software.

9. The software support agent according to claim 8, wherein a user is allowed to determine whether to send said information to a vendor of said software or not before sending said information collected by said information collecting unit related to running of said software by using said messaging software.

10. The software support agent according to claim 8, wherein a user is allowed to view and/or edit said information before sending said information collected by said information collecting unit related to running of said software by using said messaging software.

11. The software support agent according to claim 8, further comprising an information saving unit configured to save said information in local with said message format of said messaging software.

12. The software support agent according to claim 8, further comprising a receiving unit configured to receive return information and/or an update program from said vendor of said software by using said messaging software.

13. The software support agent according to claim 12, further comprising an updating unit configured to update said software by using said update program.

14. The software support agent according to claim 13, wherein a user is allowed to determine whether to update or not before said software is updated by said updating unit by using said update program.

15. A computer program product for supporting software comprising:
a computer usable medium having computer usable program code embodied therewith, the computer usable program code comprising:
computer usable program code configured to automatically collect information related to running of software;
computer usable program code configured to pack said collected information into a message format of a messaging software; and
computer usable program code configured to send said collected information related to running of said software by using said messaging software.

16. The computer program product according to claim 15, wherein a user is allowed to determine whether to send said information to a vendor of said software or not before sending said collected information related to running of said software by using said messaging software.

17. The computer program product according to claim 15, wherein a user is allowed to view and/or edit said information before sending said collected information related to running of said software by using said messaging software.

18. The computer program product according to any one of claim 15, further comprising:
computer usable program code configured to save said information in local storage medium with said message format of said messaging software.

19. The computer program product according to any one of claim 15, further comprising:
computer usable program code configured to receive return information and/or an update program from said vendor of said software by using said messaging software.

20. The computer program product according to claim 19, further comprising:
computer usable program code configured to update said software by using said update program.
